(19) United States
(12) Patent Application Publication
(10) Pub. No.: US 2012/0280027 A1
(43) Pub. Date: Nov. 8, 2012

(54) Recyclable Container Blank and Methods for Securing an Article Within a Container

(75) Inventors: Andrew David Whiteside, Bungay (GB); Alistair Fraser Moore, Bungay (GB)

(73) Assignee: UNIFORME MODULAR SYSTEMS (UK) LIMITED, Bungay (GB)

(21) Appl. No.: 13/500,637

(22) PCT Filed: Oct. 5, 2010
(86) PCT No.: PCT/GB10/01891

§ 371 Date: Jul. 6, 2012

(30) Foreign Application Priority Data
Oct. 5, 2009 (GB) 0917367.5

(51) Int. Cl. B65D 5/56; B31B 1/26

(52) U.S. Cl. 229/164.2; 493/162

(57) ABSTRACT

A container blank (1) having a base portion and front, side and rear wall portions (4, 5, 6) adapted to fold together along score or fold lines to form a container. The container having a web of material (20) therein adapted to constrain an article within the container formed from the blank. The web material is selected from one or more materials having substantially identical recycling characteristics to the material from which the blank is formed.

### FIELD OF THE INVENTION

The present invention relates to a container blank and a method of forming a container for use in packaging articles, particularly the packaging of single or multiple flat articles, such as books or video cassettes and discs such as CDs and DVDs. The invention also relates to a container package (that is, including packaged articles) formed using the container blank of the invention. The invention also relates to the method used to shape the blank into a package for constraining at least one article therein for dispatch or storage.

The invention particularly relates to a container blank made of card or similar material, the blank being modified to include an article retaining means to secure articles therein and prevent damage-causing movement within the container formed from the blank. Additionally, the invention relates to a method of manipulating the blank to firstly constrain the at least one article therein and subsequently to shape the blank into a package for dispatch or storage. The invention is described herein below with reference to flat articles such as those exemplified above, however it should be appreciated that no such limitation exists.

It will be appreciated by the skilled addressee that the invention, although directed towards the packaging of substantially flat articles, may be applied to any three-dimensional object locatable within the container and is not limited to similarly shaped articles such as books and DVDs.

### BACKGROUND TO THE INVENTION

Increasingly, customers are eschewing the time-consuming routine of travelling to purchase their shopping and/or personal and business requisites. It is now common for purchases to be made by mail order, telephone and via the Internet and email. As a consequence, for goods to be received there is a marked increase in the use of postal and courier services to deliver the purchases.

The further involvement of postal services and other delivery systems is different from the traditional mode of shopping where the customer travels to purchase articles over the counter and returns using public or their own transport means. In this scenario, packing or packaging is done at the counter or before the customer leaves, after which responsibility for damage no longer resides with the seller. As most postal and courier services either limit their liability for damage to articles delivered by them or charge significant premiums for insurance against such damage, it falls to the retailer, warehouseman or company dispatching the purchase to ensure there is minimal risk of damage during transit to the customer.

The term “postal” as used herein is intended as a convenient expression of all local, national and international dispatch and courier services, including drop-shipping services.

With the increased popularity of Internet shopping and the dispatch of ordered articles via the postal system the requirement for packaging has increased manyfold. The popularity of such websites as Amazon™ and eBay™ have increased the postal traffic of books, CDs, CDROMs and DVDs amongst others. Due to the vast turnover of dispatched articles and the inherent risks associated with the bulk handling of goods, there is a market requirement for sturdy containers. Additionally, as the volume of mail order catalogue business increases so to does the volume of returns. This has a severe consequence on the profitability of the mail order transaction and, where the returned article is damaged, the customer must bear responsibility for the damage. This condition of sale often has repercussions for customer relationships.

In other words, a fundamental requirement of any method of goods transportation is that the goods are not damaged during transport so that they reach their destinations in a non-damaged state.

It has been found in practice, that the packaging of articles such as books, records, and similar articles having at least one surface with a relatively large surface area in relation to depth or thickness of the article has presented, in terms of packaging, a significant ongoing problem. This problem manifests itself particularly in situations where the articles are packaged on a production line basis using a packaging method involving the folding of a card or like blank into a container for receiving an article to be packed.

Containers formed from blanks made of card and cardboard and other materials suitable for dispatch through the postal services are well known in the prior art. Generally, the containers are formed from a relatively simple blank having side walls separated by fold lines and one or more base and lid portions connected to one or more of the side walls by corresponding fold lines. To construct the container, an end tab of one side wall is secured to an edge portion of another side wall and the or each base portion is folded and secured to form an open-mouthed container. When the or each article to be dispatched has been placed within the container, the or each lid portion is folded and secured. The means of securing the portions to form the container is normally selected from gluing, stapling or applying adhesive tape.

It will be appreciated that unless the container is designed to receive the specific article(s) to be dispatched, further packaging materials will be required to prevent the article(s) moving about within the container. In the packaging industry generally there is a move to obviate extraneous packaging materials and in some countries there are regulations and legislation to prevent wasteful packaging practices.

The invention is directed to overcoming some of the established disadvantages associated with prior art containers, particularly those realising a container which is adapted for encapsulating or otherwise securing one or more articles within the container to prevent damage due to movement within the container during transit to its destination.

In an attempt to obviate some of the disadvantages highlighted above, a solution suggested in the prior art is to utilise a web of lining material to secure the articles within the container.

One established solution is to place the articles for dispatch in a tray, usually of a cardboard material. The tray and articles are then wrapped by a web of plastics material which is subsequently heated to effect a shrink-wrapped package. Alternatively, the web or film is tensioned around the article(s) by folding elements of the tray to which the web is attached. This package is then placed into a pre-formed container which is finally sealed and marked for dispatch. This arrangement, however, has its own disadvantages including that, although the articles are bound together, the tray will often move sufficiently in the container to dislodge the articles from the tray. Furthermore, this arrangement does not avoid the use of unnecessary additional packaging materials and includes an extra stage in the packaging process.

In another solution, United Kingdom Patent No. GB 2 343 885 describes a container blank to which a sheet or web of lining material is secured. This lining material is shrink-wrappable so that articles may be placed directly into the container and secured in situ.

There has been an increasing awareness for the need for packaging to be easily recyclable and, although the general public are increasingly involved in the separation of recyclable and non-recyclable waste, where there is separation of materials required it is perceived as being simpler simply to discard the entire packaging for processing as non-recyclable waste. More recently, packaging legislation has pushed packaging manufacturers towards simpler and less obtrusive packaging use to cut down the volume of packaging material that is used for individual containers.

Consequently, there is a perceived need to provide a container having an article retaining means which is adaptable to conform with the article or articles contained therein to minimise movement of the or each article within the container during transit.

It is an object of the present invention to alleviate the above disadvantages and to provide a packaging system that is wholly recyclable and has an article retaining means which is adaptable to conform with one or more articles contained therein.

It is also an object of the present invention to provide a method for the manipulation of a carton blank to constrain at least one article therein for dispatch or storage.

### SUMMARY OF THE INVENTION

In its primary aspect, the present invention provides a container blank, so sized and shaped as to form a container having a base and side and end walls, there being secured therein a web of material adapted to retain an article within the container, wherein the web material is selected from one or more materials having substantially identical recycling characteristics to the material from which the blank is formed.

Accordingly, the present invention provides a container blank comprising:
a base portion having a pair of opposed side wall portions and an opposed front wall portion and rear wall portion, each wall portion being connected to the base portion at a fold line, each section being adapted for folding about the respective fold lines;
the front and rear wall portions each having a lid section connected via respective fold lines; and
the base at least having attached thereto a web of material adapted to retain an article within a container formed from the blank,
   wherein the web material is selected from one or more materials having substantially identical recycling characteristics to the material from which the blank is formed and includes adhesive thereon adapted to adhere only to corresponding areas of the web material.

Conveniently, the material adapted to retain an article within the container formed from the blank is a card or paper web.

Advantageously, the material web is presented so that articles to be retained within the container are placed within the base portion over the material web which is then closed and tensioned to secure the or each article therein.

Preferably, the material web has cohesive portions thereon, the portions being brought together so that the cohesive regions bond across their entire free area until the bonded section abuts the upper surface of the or each article held therein, thereby creating the constraining tension to the article(s).

Conveniently, the cohesive portion includes an adhesive adapted to adhere only to surfaces having like adhesive thereon.

Advantageously, the cohesive portions are spray coated with a cold-seal adhesive.

In an alternative arrangement, an inner surface of a first material web portion includes an adhesive region which is adapted to overlie the outer surface of a second material web portion when one or more articles are to be retained therein and adhere to said outer surface when manual pressure is applied.

In one such arrangement a protective film is applied to the adhesive region to prevent adherence to other surfaces.

The present invention further provides a method of forming a container from a container blank of the type having an article retaining portion thereon, the method comprising:
placing one or more articles onto a base portion of a container blank having an article retaining portion secured thereto;
bringing together the free ends of the material web of the article retaining portion so that co-adhesive (cohesive) regions are brought together across their free surfaces;
closing the side edges of the article retaining portion by applying pinching pressure to the free edges thereof and folding the resultant bonded surface so as to form a neat article retaining profile within and secured to the base portion of the carton blank;
folding the plurality of foldable sections of the container blank so as to form a container about the article retaining profile;
closing the lid portions in an overlying relationship so that pre-applied pressure-sensitive adhesive thereon seals the lid closed; and
conveying the closed container for dispatch or storage.

Conveniently, co-adhesive regions are brought together with sufficient force to activate the adhesive and create securing tension across the article retaining portion to constrain the or each article within.

Advantageously, the method includes bringing together cohesive portions of the web material so that the cohesive regions bond together across their entire free area until the bonded section abuts the upper surface of an article held therein, thereby creating a constraining tension to the or each article.

Alternatively, the method includes overlying a first material web portion having an adhesive portion thereon and under wrapping tension adhering it to an exposed surface of a second material web portion within which articles to be secured are constrained.

### BRIEF DESCRIPTION OF THE DRAWINGS

The invention will now be described more particularly with reference to the accompanying drawings which show, by way of example only, one embodiment of container blank and method of forming a container therefrom in accordance with the invention. In the drawings:

FIG. 1 is a perspective view of a suitably shaped container blank to which an article retaining portion may be provided thereon to effect the invention;

FIG. 2 is a perspective view similar to that of FIG. 1 in which a plurality of adhesive strips or glue lines have been applied to the base region of the blank and a web of material secured thereto

FIG. 3 is a perspective view of a lined container blank in which an article to be retained is placed on the article retaining web in a position over the base portion of the container blank;

FIG. 4 is a perspective view showing the free ends of the article retaining web being brought together over the or each article;

FIG. 5 is a perspective view similar to that of FIG. 4 in which the free ends have been pressed together so that adhesive applied thereto bonds the ends together and the total available area of the ends of the article retaining web are pressed together to apply constraining tension to the articles;

FIG. 6 is a perspective view showing the final stages of sealing the article within the material web where the adhered portion of the web is folded over the profile of the article and pressure is then applied to the edge areas of the web to constrain the article securely to the container blank;

FIG. 7 is a perspective view of the final stages of forming a container around the article profile; and

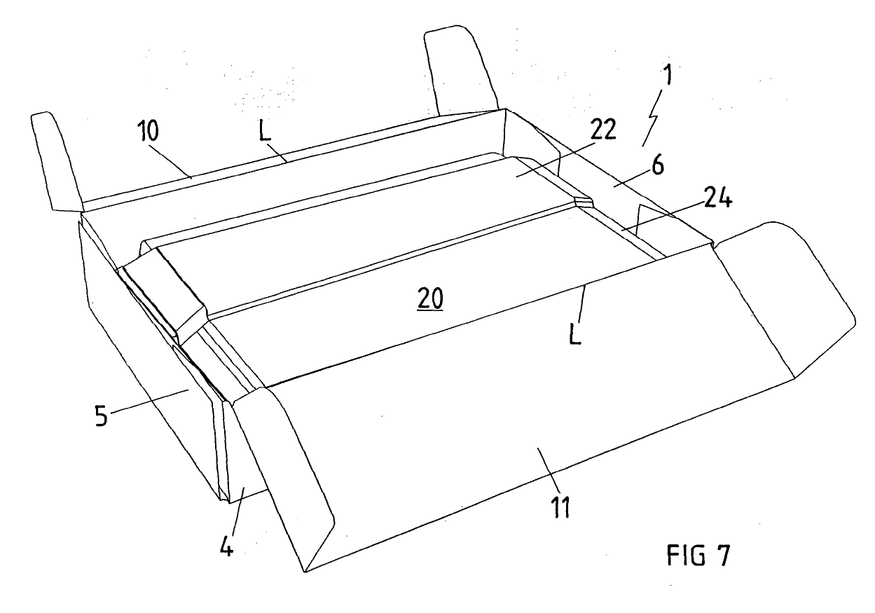

FIG. 8 is a perspective view of a formed shipping pack ready for labelling and dispatch or for storage.

### DETAILED DESCRIPTION OF THE PREFERRED EMBODIMENT

In the description that follows, the terms “side walls” and “end walls” are used conveniently to describe pairs of opposed walls and should not be considered as limiting. Certain portions or tabs are also described in a similar fashion, again on to assist the reader.

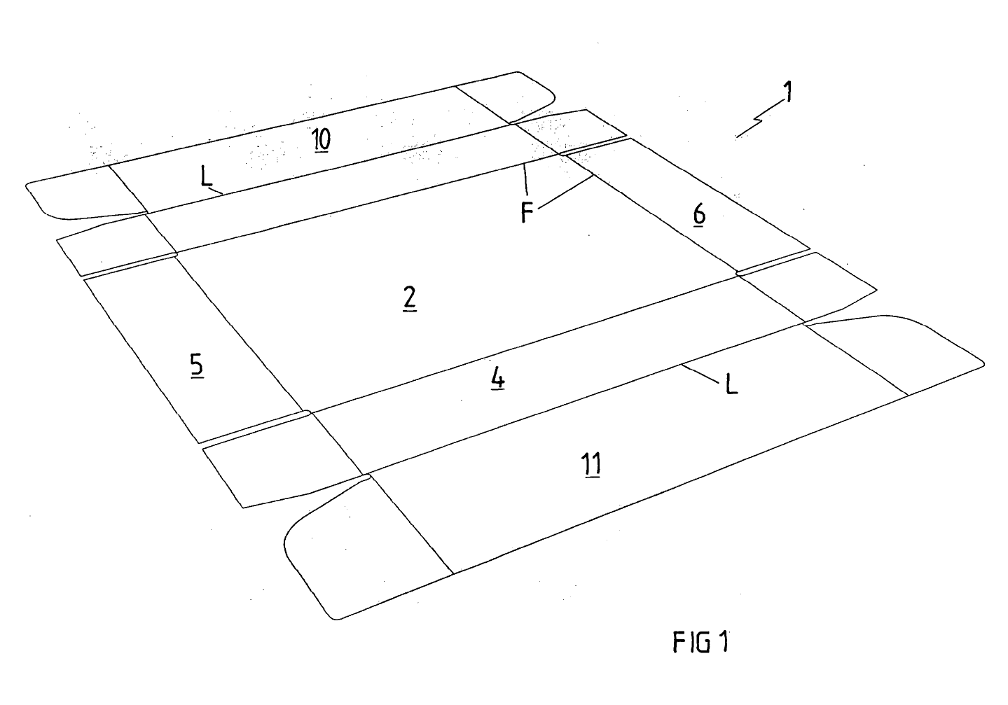

Referring to the drawings and initially to FIG. 1, a container blank 1 is cut from craft card or cardboard and includes a central land 2 that forms the base region of a container formed from the blank. Fold lines F are provided around the central land or base 2 to define end 3,4 and side 5,6 walls which in turn define the depth of the shipping pack to be formed by the blank.

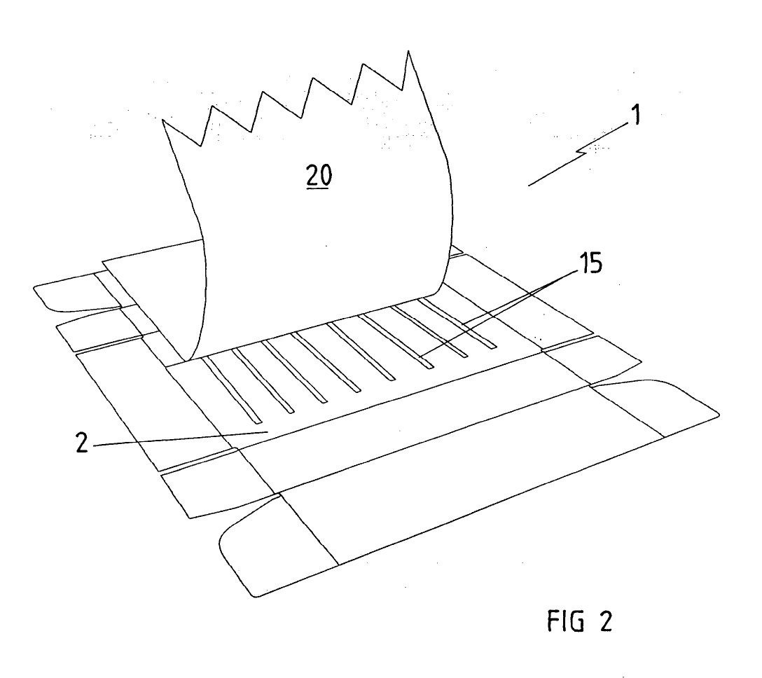

The end walls 3,4 also act as risers for their respective lid portions 10,11, each connected to the end walls via fold lines L. Each of the base 2, end wall 3,4 and lid portions 10,11 have side wall forming elements which together define the shipping pack dimensions and therefore the capacity of the container formed by the blank. FIG. 2 shows a series of parallel glue lines 15 to allow a web of cohesive material 20 comprising a flexible card or paper web to be applied to the container blank 1. Most conveniently, the material web is rolled onto the blank and adheres to the glue lines 15 already placed on the base region thereof. The skilled reader will appreciate that there are many other ways of applying the material web to the base, however, by applying it in the manner herein described there is no need for registration of the position of the material web with respect to the container blank during the process of lining said blanks.

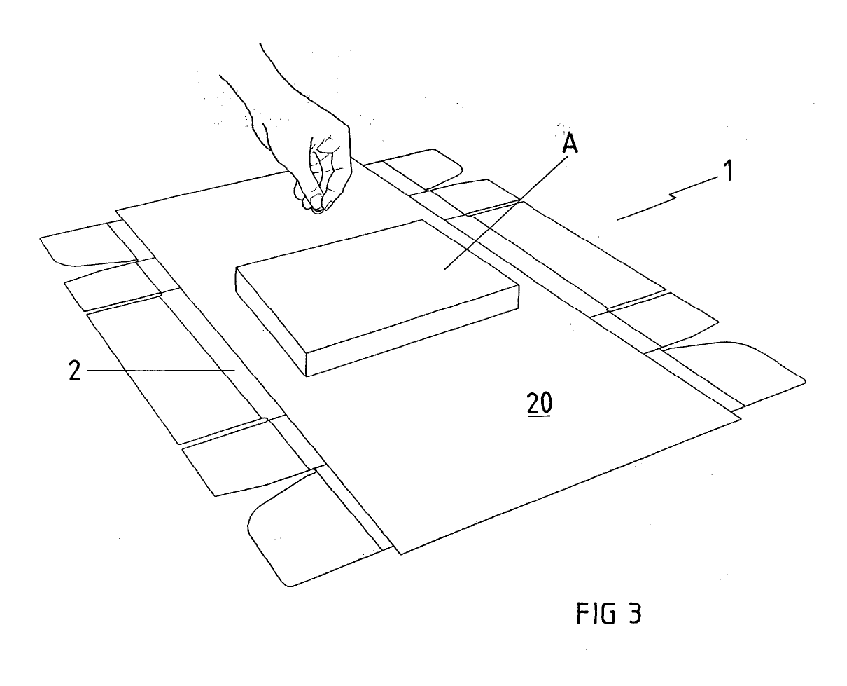

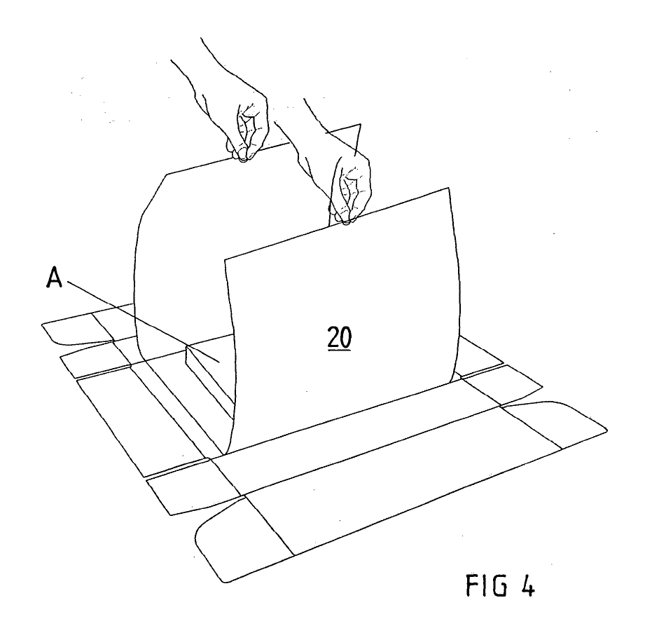

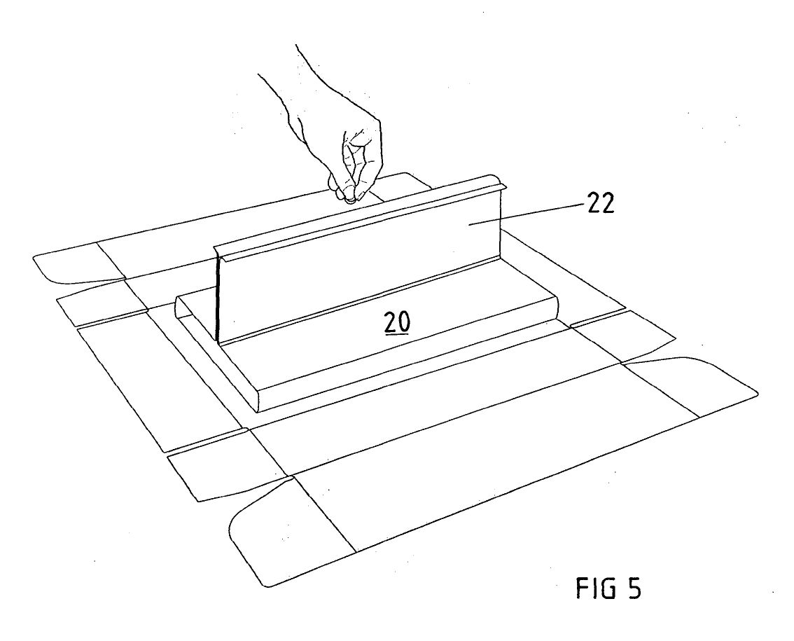

As shown in FIG. 3, the or each article A to be dispatched in the shipping pack formed from the container blank is placed on top of the material web centrally in a region corresponding to the base. The free ends of the material web 20 are then lifted up and brought together as shown in FIG. 4 where they can either be folded over one another or the inner faces thereof are pressed together according to the positioning of the cohesive surfaces. In the arrangement illustrated in FIG. 5, the material web is pressed together in book leaf fashion so that matching regions of cold seal adhesive tack together when sufficient pressure is applied. Further regions of the book leaved surfaces are brought together until the article to be conveyed or stored is securely retained by the material web to the base. The flap 22 of material thus formed is folded over to overlie the profile assumed by the article within the web.

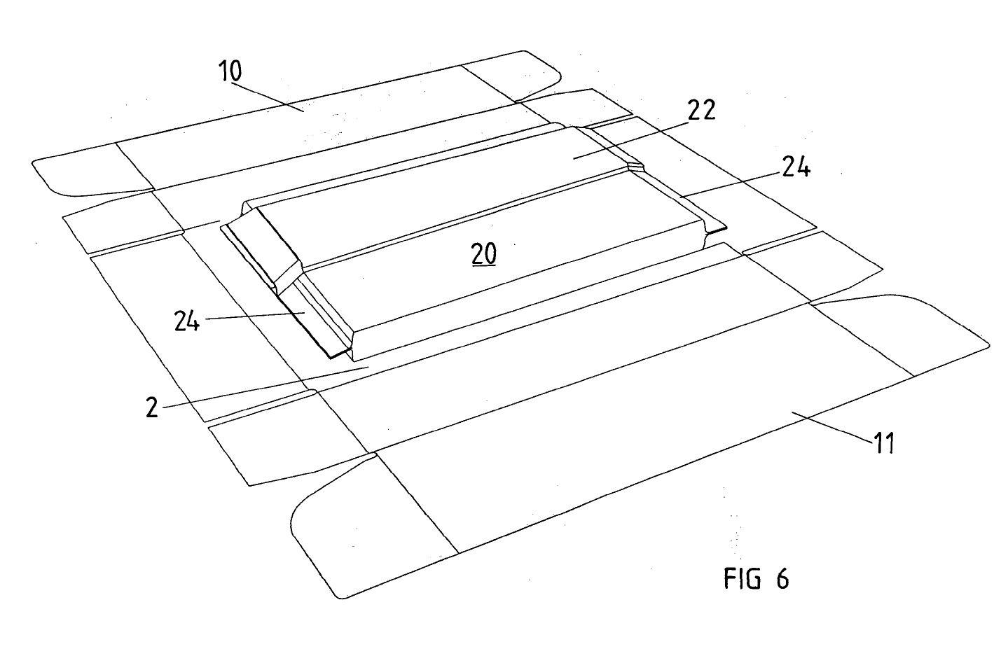

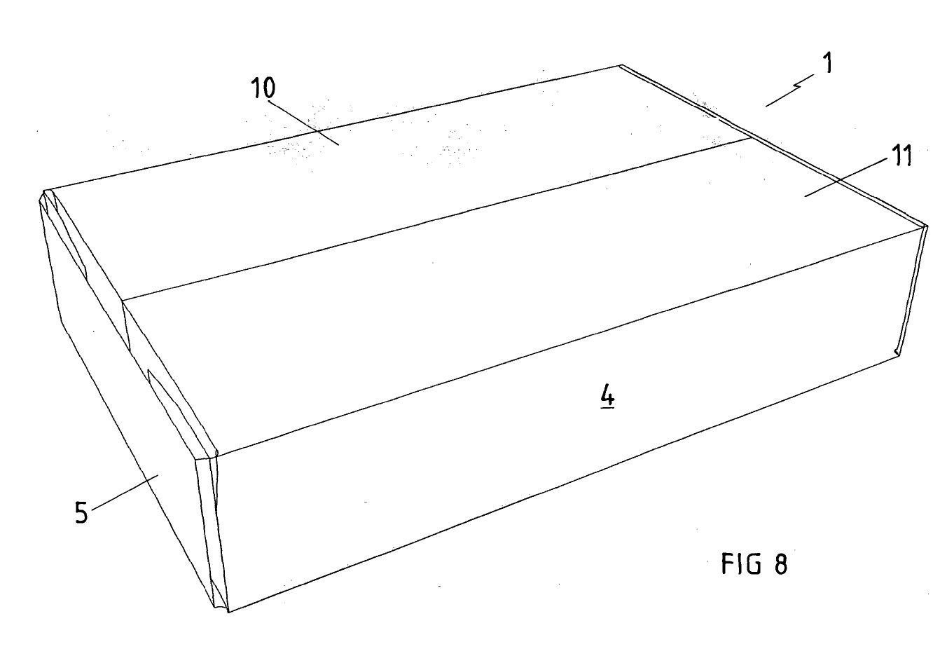

Side portions 24 of the material web overlying the retained article are brought together using manual pressure, as shown in FIG. 6, to further restrain the or each article from moving within the material web. Once secure, the container 7 may then formed around the constrained article, as illustrated in FIG. 8, before the lid portions 10,11 are closed over with their respective side wall forming elements or flaps being folded within the side walls 5,6 of the container.

The final form of the shipping pack is shown n FIG. 8 ready to be labelled for dispatch or storage.

It will be appreciated by the skilled addressee that the use of flexible card or paper as the material web provides the major advantage of the present invention, in that the container is entirely recyclable rather than extra costs being incurred in packaging levies and recycling costs which is now predominant with packaging using multiple material types or materials which can not be recycled at the same time or same process.

It will of course be understood that the invention is not limited to the specific details described herein, which are given by way of example only, and that various modifications and alterations are possible within the scope of the appended claims.

1.-15. (canceled)

16. A container blank which comprises:
a base portion having a pair of opposed side wall portions and an opposed front wall portion and rear wall portion, each wall portion being connected to the base portion at a fold line, each portion being adapted for folding about the respective fold lines;
the front and rear wall portions each having a lid portion connected via respective fold lines; and
the base portion at least having attached thereto a web of material adapted to retain an article within a container formed from the blank,
wherein the web material is provided as a unitary sheet and is selected from one or more materials having substantially identical recycling characteristics to the material from which the blank is formed and includes adhesive thereon adapted to adhere only to corresponding areas of the web material
and wherein the blank has a substantially rectangular profile configured so as to be presentable as a flat stackable lined blank.

17. A container blank as claimed in claim 16, in which the material adapted to retain an article within the container formed from the blank is a card or paper web so sized and shaped so as not to extend beyond the periphery of the profile defined by the blank, thereby preventing snagging and facilitating increased throughput.

18. A container blank according to claim 16, in which the material web is secured approximately midway along its length to the base portion so that articles to be retained within the container are placed within the base portion over the material web which has free ends that are drawn over the or each article and then closed and tensioned to secure the or each article therein.

19. A container blank according to claim 16, in which the web material forms an article retaining profile, around the or each article, secured to the base portion only.

20. A container blank according to claim 19, in which the blank is formable into a shipping pack around the article retaining profile.

21. A container blank according to claim 16, in which the material web has cohesive portions thereon, the portions being brought together so that the cohesive portions bond across their entire free area until the bonded section abuts the upper surface of an article held therein, thereby creating the constraining tension to the or each article.

22. A container blank according to claim 21, in which the cohesive portion includes an adhesive adapted to adhere only to surfaces having like adhesive thereon.

23. A container blank according to claim 21, in which the cohesive portions are spray coated with a cold-seal adhesive.

24. A container blank as claimed in claim 16, in which an inner surface of a first material web portion includes an adhesive region which is adapted to overlie the outer surface of a second material web portion when one or more articles are to be retained therein and adhere to said outer surface when manual pressure is applied.

25. A container blank as claimed in claim 16, in which a protective film is applied to the adhesive region to prevent adherence to other surfaces.

26. A method of forming a container from a container blank of the type claimed in claim 16 having attached to a base portion thereof a web of material adapted to retain an article within a container formed from the blank, the web material being selected from one or more materials having substantially identical recycling characteristics to the material from which the blank is formed, the method comprising:
placing one or more articles onto a base portion of a container blank having an article retaining portion secured thereto;
bringing together the free ends of the material web so that cohesive portions are brought together across their free surfaces;
closing the side edges of the article retaining portion by applying pinching pressure to the free edges thereof and folding the resultant bonded surface so as to form a neat article retaining profile within and secured to the base portion of the carton blank;
folding the plurality of foldable portions of the container blank so as to form a container about the article retaining profile;
closing the lid portions in an overlying relationship so that pre-applied pressure-sensitive adhesive thereon seals the lid closed; and
conveying the closed container for dispatch or storage.

27. A method of forming a container from a container blank according to claim 26, in which cohesive portions of the web material are brought together with sufficient force to activate the adhesive and create securing tension across the article retaining profile to constrain the or each article within.

28. A method of forming a container from a container blank according to claim 26, in which the method includes bringing together cohesive portions of the web material so that the cohesive regions bond together across their entire free area until the bonded section abuts the upper surface of an article held therein, thereby creating a constraining tension to the or each article.

29. A method of forming a container from a container blank according to claim 26, in which the method includes overlying a first material web portion having an adhesive portion thereon and under wrapping tension adhering it to an exposed surface of a second material web portion within which articles to be secured are constrained.
